(19) United States
(12) Patent Application Publication
(10) Pub. No.: US 2011/0125909 A1
(43) Pub. Date: May 26, 2011

(54) In-Session Continuation of a Streaming Media Session

(75) Inventor: Stephane H. Maes, Freemont, CA (US)

(73) Assignee: Oracle International Corporation, Redwood Shores, CA (US)

(21) Appl. No.: 12/949,287

(22) Filed: Nov. 18, 2010

Related U.S. Application Data
(60) Provisional application No. 61/263,134, filed on Nov. 20, 2009.

(51) Int. Cl. G06F 15/16

(52) U.S. Cl. 709/227; 709/231

(57) ABSTRACT

Methods and systems are provided for forwarding a media streaming session from one node to another node while the session is in progress. A streaming server may store data sent between nodes in the session. When one node is forwarded to a new node, the stored data may be used to transition to the new node with little or no interruption in data sent between nodes in the session. A user interface may allow a user to set preferences and control other aspects of the session forwarding features.

### CROSS-REFERENCES TO RELATED APPLICATIONS

This application claims priority to U.S. Provisional Application No. 61/263,134, filed Nov. 20, 2009, the disclosure of which is incorporated by reference in its entirety for all purposes. This application is related to co-pending application entitled “Interface for Communication Session Continuation” Attorney Docket No. 021756-049100US, filed ______, the disclosure of which is incorporated by reference in its entirety for all purposes.

### BACKGROUND OF THE INVENTION

Session Initiation Protocol (SIP) and other such signaling protocols are commonly used for establishing sessions over an Internet Protocol (IP) network. Generally speaking, SIP, or in general any session-based or message-based exchange, can be used by an initiating device to request a connection with a server and/or one or more other devices and to establish a streaming session with the other device(s). Such a session can be used for a variety of purposes such as Internet telephony, e.g., Voice over Internet Protocol (VoIP), audio and/or video conferencing, interactive gaming, multimedia streaming, multimedia instant messaging, etc. Sessions may be described using the Session Description Protocol (SDP), which provides a format that allows for description of session initialization and other parameters, or similar protocols.

Some communications systems, such as Private Branch Exchange (PBX) phone systems allow for in-progress calls to be forwarded, such as where the call is forwarded from one party to another, or from one phone handset to another. These communication systems are typically internal to a single entity, such as where a corporation maintains its own PBX. For example, a traditional public switched telephone network (PSTN) does not provide in-progress call forwarding. Similarly, modern multimedia systems and networks such as voice over IP (VoIP), softphones, cellular phones, and other video and audio conferencing systems and protocols typically do not provide in-progress call forwarding. Thus, if a party wishes to forward a multimedia session to a new party, node, or other recipient, the session typically is disconnected and a new session initiated with the new recipient.

### BRIEF SUMMARY OF THE INVENTION

Embodiments of the invention provide methods and systems for forwarding a media streaming session from one node to another node while the session is in progress. A streaming server may store data sent between nodes in the session. When one node is forwarded to a new node, the stored data may be used to transition to the new node with little or no interruption in data sent between nodes in the session.

According to an embodiment of the invention, a method of forwarding an in-progress media streaming session may include storing data exchanged between a first node and a second node in a database during a media streaming session between the first node and the second node during which each of the first node and the second node is connected to a session continuity manager; initiating a new connection between a new node and the session continuity manager; after the new connection is established, disconnecting the first node; and forwarding data sent by the second node to the new node. The method may also include sending stored data previously sent by the second node to the new node. The method also may include forwarding data sent by the first node, data sent by the new node, or both to the second node, The forwarded data may be identified as originating at the new node. The forwarded data may be read from the database prior to forwarding to the second node. Data may be sent from the new node to the second node before the first node is disconnected, and session data may be replicated between the first node and the new node. The new connection may be initiated by the new node, the session continuity manager, or a third party. During initiation of the new connection, the session continuity manager may identify itself to the new node as the second node. The session continuity manager, the first node, and the new node may be connected by a third party call control mechanism.

The connection between the new node and the session continuity manager may be initiated in response to a request to forward the session to the new node. The request may be made prior to initiation of the media streaming session between the first node and the second node. The request may be made automatically based on a preference of at least one of the nodes, initiated by a user of at least one of the first node and the second node, or a combination thereof. The request may be made on a channel separate from the media streaming session.

The first node and the new node may be on different networks. The first node, the second node, or both, may be connected to the session continuity manager after initiation of the media streaming session.

The media streaming session may be an audio session, a video session, a web conference, or a combination thereof. Each of the nodes may be, for example, a PSTN node, a VoIP node, a mobile TV node, or an IPTV node.

According to an embodiment of the invention, a system for managing a media streaming session may include a database configured to store session data for a media streaming session between a first node and a second node and a session continuity manager in communication with the database, where the session continuity manager configured to communicate with a plurality of nodes including the first node and the second node. The session continuity manager may be configured to forward the media streaming session from the first node to a new node while the media streaming session is in progress.

### BRIEF DESCRIPTION OF THE DRAWINGS

FIG. 1 shows a schematic of an example system for maintaining and/or forwarding a session according to embodiments of the invention.

FIG. 2A shows a schematic of an example system for maintaining and/or forwarding a session according to embodiments of the invention.

FIG. 2B shows a schematic of an example system for maintaining and/or forwarding a session according to embodiments of the invention.

FIG. 3 shows a process for forwarding a session according to an embodiment of the invention.

FIG. 4 shows a process for forwarding a session according to an embodiment of the invention.

FIG. 5A shows a schematic illustration of a user agent device according to an embodiment of the invention.

FIG. 5B shows an example user interface according to an embodiment of the invention.

FIG. 5C shows an example user interface according to an embodiment of the invention.

FIG. 5D shows an example user interface according to an embodiment of the invention.

FIG. 6 shows a simplified schematic of an example device suitable for use in embodiments of the invention.

### DETAILED DESCRIPTION OF THE INVENTION

Embodiments of the invention provide methods and systems for forwarding a media streaming session from one node to another node while the session is in progress. A session continuity manager or a component thereof may store data sent between nodes in the session. As used herein, “forwarding” a session refers to continuing an in-progress session at a new node, often without any perceptible interruption in service or data transfer between nodes in the session. It may be distinguished from, for example, “call forwarding,” in which every incoming call to a specific phone number or physical device is re-routed to a different number or device. When a session is forwarded from one node to a new node, the stored data may be used to transition the session to the new node with little or no interruption in data sent between nodes in the session. This process of forwarding also may be referred to as session continuity, since it is not required that the node from which the session is “forwarded” subsequently disconnect from the session.

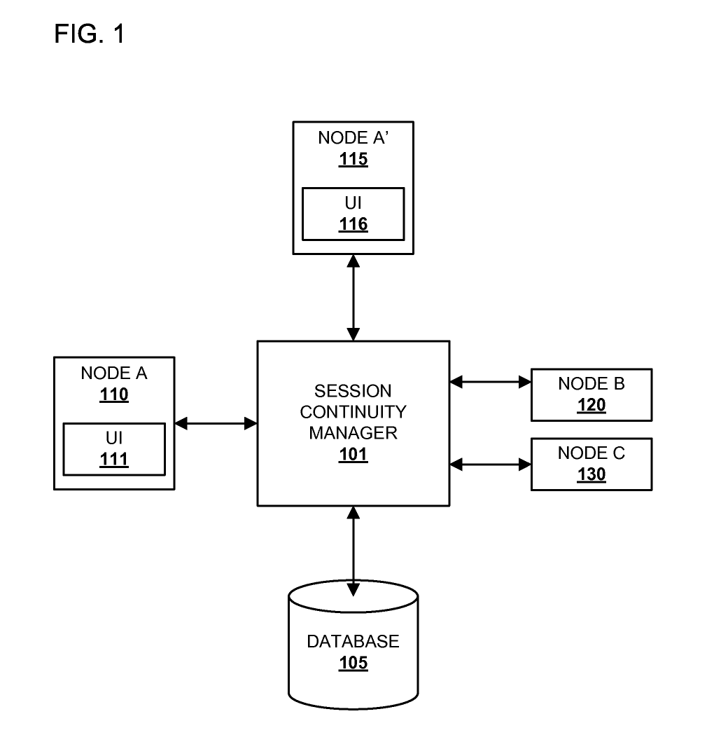

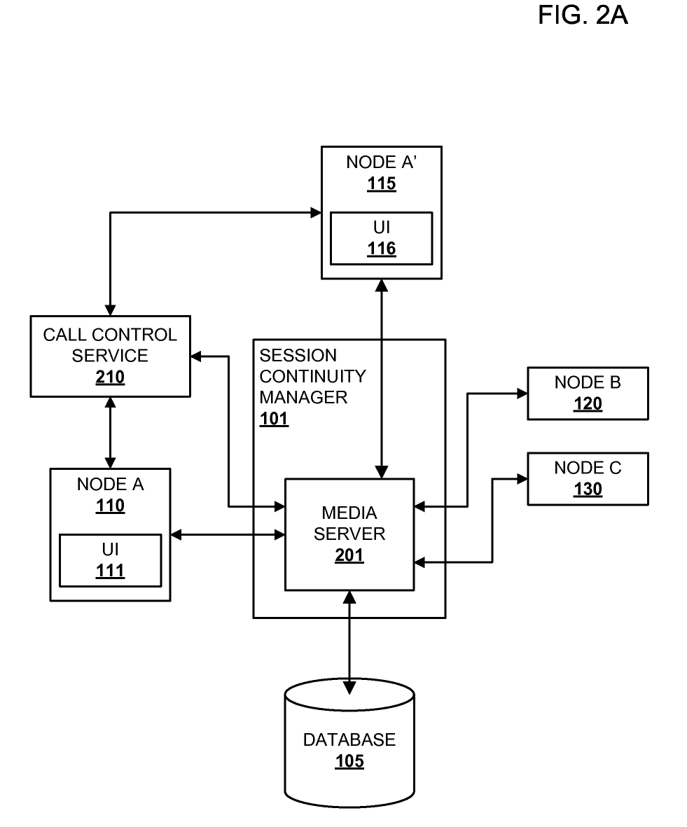

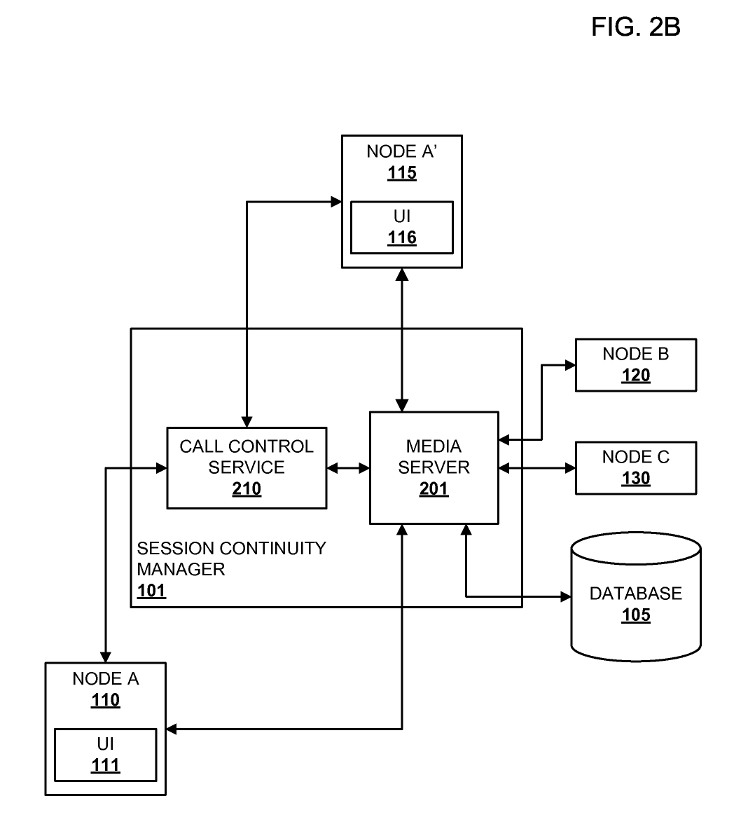

FIGS. 1 and 2 show schematics of example systems for forwarding a session according to embodiments of the invention. A first node 110 may be connected to one or more nodes 120, 130, during a media streaming session. The session may be any appropriate communication session including, but not limited to, audio conferencing, video conferencing, web conferencing, VoIP, cellular, and other streaming media formats and protocols. As used herein, a “node” refers to an endpoint of the session. Nodes may include communication devices used to connect to the session such as a phone handset, portable electronic device, general purpose computer, or other device. A node also may be an integrated hardware device, a sever such as a media server, a teleconference, videoconference, or other conference server, an IVR and a voice server, and/or a software-implemented device or application. In some embodiments, multiple nodes may exist on the same physical device, such as where a user agent device can utilize multiple communication interfaces, such as WiFi and cellular interfaces. Related nodes also may be separate physical devices, such as a mobile phone and a land-line phone. A node may be used by multiple users, or a single user may use each node

A session may be managed by a session continuity manager 101 to which each node is connected during the session. The continuity manager may include, for example, a media server, a call controller, or combinations thereof, such as are described in co-pending U.S. application Ser. No. 11/877,129 entitled “Network Agnostic Media Server Control Enabler,” filed Oct. 23, 2007, and U.S. application Ser. No. 11/949,930 entitled “Call Control Enabler Abstracted from Underlying Technologies,” filed Dec. 4, 2007, the disclosure of each of which is incorporated by reference in its entirety for all purposes. Some embodiments of the invention may incorporate session and media exchange control and access concepts such as those described in U.S. application Ser. No. 11/848,347, entitled “Factoring Out Dialog Control and Call Control,” filed Aug. 31, 2007, the disclosure of which is incorporated by reference in its entirety for all purposes. The session continuity manager may be a single server or collection of servers, or it may be a system having discrete parts such as a media server, a call control server, and other components. The session continuity manager may include or be in communication with an application that directs calls via, for example, a call controller or call control enabler. As described in further detail below, some call control functionality also may be provided by a client or user agent node that requests a call transfer to another node.

Each node 110, 120, 130 may connect to the continuity manager over any appropriate network connection, and different nodes may be on different types of networks, different physical networks, and combinations thereof. Session and identity management and network connectivity for each node may be managed as described in co-pending U.S. application Ser. No. 10/890,786 entitled “Method and Apparatus for Personalization and Identity Management,” filed Jul. 13, 2004, U.S. application Ser. No. 10/856,560 entitled “Roaming Across Different Access Mechanisms and Network Technologies,” filed May 28, 2004, now U.S. Pat. No. 7,167,705, and U.S. application Ser. No. 11/424,414 entitled “Best Effort Seamless Network Switch in a Media Streaming Session,” filed Jun. 15, 2006, the disclosure of each of which is incorporated by reference in its entirety for all purposes.

The continuity manager 101 may include or be in communication with a database 105 configured to store data associated with the streaming media session to which the nodes are connected. For example, where the session includes a video conference, the database 105 may store audio, video, or a combination of audio and video sent between the nodes during the session. As a specific example, if Node A 110 and Node B 120 are connected in an audio session such as a VoIP call, the continuity manager 101 may record audio sent between the nodes 110, 120 in the database 105. The continuity manager may record a portion of the streaming media associated with the session, such as where a recording of a set time period is kept, or it may record the entirety of the streaming media. Each of the nodes described with respect to FIG. 1 may be any suitable node type as previously described. For example, each of Nodes A and B may be a separate user agent or device, a computer-executed application, a server or other general-purpose computer, or other node type.

Since all data transferred during and associated with the session may be stored by the continuity manager, some embodiments may provide for intercept, monitoring, or duplication of media streaming or transfer sessions. For example, data transferred between Nodes A and B as described above may be stored by the continuity manager after the session has ended. This stored data may be used at a later time to reconstruct or replay the session, to extract information about media exchanged during the session, or otherwise examine or duplicate the session between A and B. Similarly, the copied data may be examined while the session is still connected, such as to monitor the content of media exchanged during the session. Thus, an embodiment of the invention may provide for interception, duplication, and/or monitoring of a media streaming or exchange session.

In an embodiment of the invention, the session for Node A may be forwarded to a new node, such as Node A′ (115). The new node may be a separate physical endpoint, such as where a session is forwarded to a new user agent, or it may represent a relocation of the user or user agent originally connected at Node A (110). As a specific example, a session may be forwarded from a cellular telephone 110 connected to the continuity manager via a cellular network, to a general purpose computer 115 connected via the Internet. As another specific example, the first node 110 may be a cellular telephone operating on a cellular network, and the new node 115 may be a voice-over-IP (VoIP) client operating on the same device. To forward the session, data intended for the original node 110 may be read from the database 105 and sent to the new node 115. For example, data sent by another node 120, 130 may be stored in the database. When the session is to be forwarded and a connection to the new node 115 is established, the stored data may be sent to the new node 115. The data may be sent so to as to appear to the new node 115 that it is coming directly from a sending node 120, for example by identifying the sending node 120 as the sender of the data. The process of transferring a session from an initial node 110 to a new or additional node 115 may be referred to as forwarding the session to the new node. Forwarding a session may include redirecting media intended for the original node to the new node. In an embodiment, the session may be forwarded with little or no loss of data between the other nodes 120, 130 in the session and the forwarded node 110, 115.

In some configurations, the nodes 110, 115 and the continuity manager 101 may be connected by a call control service 210. Such a service may be implemented using third-party call control technology such as SIP B2BUA or via a call control enabler such as described in U.S. application Ser. No. 11/877,129, entitled “Network Agnostic Media Server Control Enabler,” filed Oct. 23, 2007, and U.S. application Ser. No. 11/949,930, entitled “Call Control Enabler Abstracted from Underlying Technologies,” filed Dec. 4, 2007, the disclosure of each of which is incorporated by reference in its entirety for all purposes. Specific examples of call control systems include those available from the Parlay Group, available from http://www.parlay.com. Such a configuration may be useful, for example, when the session is a SIP or voice communication session or other multimedia session.

As described in further detail below, a node may include a user interface 115, 116. The user interface may provide interface elements that allow a user to view, control, or otherwise interface with session forwarding functionality as described herein.

In an embodiment, the session between a first set of nodes, such as between node 110 node 115, may be shared, preserved, or replicated to a media streaming session between a second set of nodes, such as node 115 and another node 120. Session data replication may be used, for example, when the session is configured to transfer generic data as opposed to communication data such as voice, video, and combinations thereof. Replication may reduce or eliminate “dropped” data, i.e., data loss that occurs as the result of the session being forwarded. Session replication is described in further detail in U.S. application Ser. No. 10/890,786 entitled “Method and Apparatus for Personalization and Identity Management,” filed Jul. 13, 2004, the disclosure of which is incorporated by reference in its entirety for all purposes.

In an embodiment, some or all of the nodes may be on different networks or types of networks. Specifically, the initial node 110 and the node to which the session is forwarded 115 may be on different networks. Related details regarding the use of different networks in a media streaming session are available in U.S. application Ser. No. 10/856,560 entitled “Roaming Across Different Access Mechanisms and Network Technologies,” filed May 28, 2004, now U.S. Pat. No. 7,167,705, the disclosure of which is incorporated by reference in its entirety for all purposes.

The nodes may be different types of end points and may communicate using various and different protocols. Examples of types of nodes that may be used include PSTN, VoIP, mobile TV, IPTV, cellular phones and systems, web conference, videoconference, and other physical systems and protocols, including other platforms and protocols described herein and known in the art.

FIGS. 2A and 2B show example systems for maintaining and/or forwarding a session according to another embodiment of the invention, in which the session continuity manager 101 includes a media server 201 (FIG. 2A) and a call control service (FIG. 2B). The media server may manage mixing, multiplexing, and/or storage of the data exchanged during the session. According to an embodiment, an external call control service 201 as previously described may manage connection and disconnection of the nodes 110, 115, 120, 130 to and from a media streaming session. The call control service 201 may perform signaling between nodes 110 and 115 and the media server 101. The call control 201 also may handle signaling between other nodes 120, 130. Nodes 120, 130 also may communicate directly with the media server 101. For example, a media streaming session may be initiated by any of the call control service 201, the network, the media server 101, or by client nodes 110, 115, 120, and 130. In an embodiment, the call control service 201 also may be partly or entirely implemented by the session continuity manager.

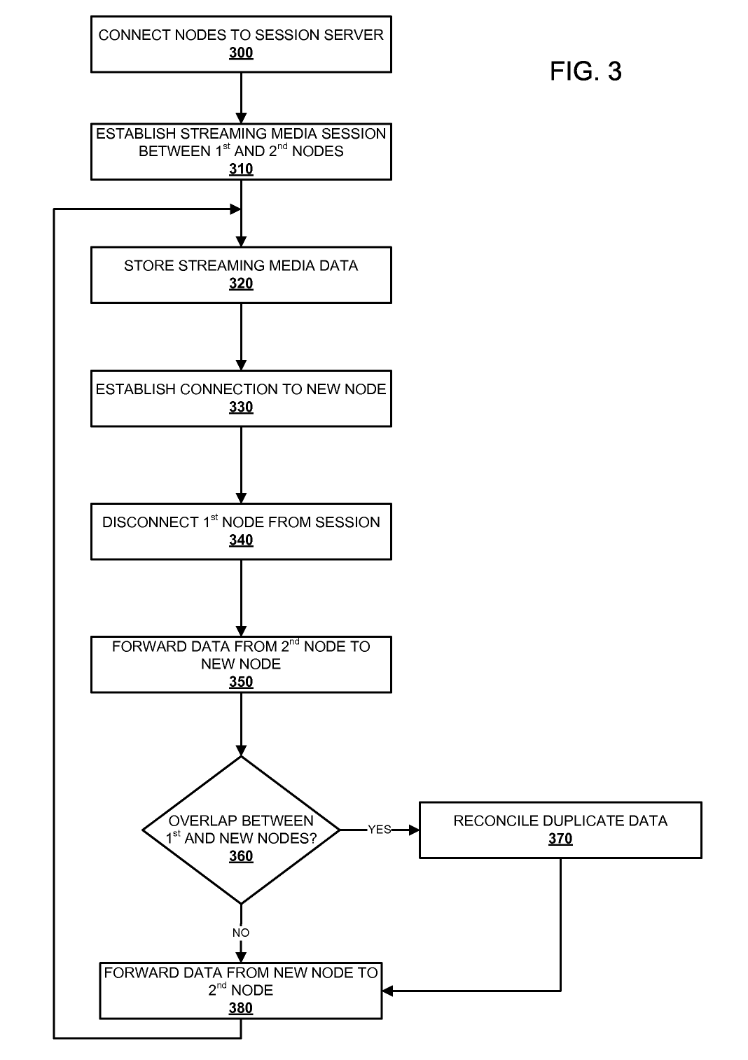

FIG. 3 shows a process for forwarding a session according to an embodiment of the invention. At 300, two or more nodes may be connected to a session continuity manager or system as previously described. In a configuration where the continuity manager includes a call control service or call controller as previously described, the continuity manager may initiate, mediate, or otherwise manage the connection between the nodes, or the nodes may establish the session initially and then connect to the continuity manager. Call control also may be performed by an external call control service, as previously described. At 310, a streaming media session may be established between two nodes or more in a network. The streaming media session may be established at 310 before or after the nodes are connected to the continuity manager at 300. The media transferred during the streaming media session may be generic data, or it may be multimedia or communication data such as voice, instant messaging, video, web conferencing, and combinations thereof. The nodes may be connected to a continuity manager as previously described. The nodes may be connected to the continuity manager prior to establishing the streaming media session, or they may be connected after the streaming media session is established. At 320 the continuity manager may store data transferred between the nodes during the streaming media session.

At 330, a new node, to which the session for the first node is to be transferred, may be connected to the session. That is, the new node may join the session in progress. The connection may be initiated by the continuity manager, the new node, one of the nodes already in the session, or a third party.

At 340, the first node may be disconnected from the session. The first node may be disconnected immediately after the new node is connected to the session, or there may be a period of time where the new node and the first node are both connected.

At 350, to finish forwarding the session from the first node to the new node, data sent by the second or other nodes that was intended for the first node is, instead, sent to the new node. Data may be sent to the new node while the first node is still connected, and the data may be sent to both the first node and the new node. In some configurations, the data may include recorded data including data previously exchanged in the session, sent by the continuity manager to the new node. Data sent by the continuity manager may be identified as originating at the second or other sending node, so that from the perspective of the new node it appears to be sent directly from the second or other sending node to the new node, without having been processed or stored by the continuity manager. In some embodiments, data may be mixed and shared between the different nodes, such as in a multimedia conference. In such a configuration, the continuity manager may perform mixing and/or multiplexing functions. Some data transferred to the new node at 350 may be transferred prior to disconnecting the first node from the session at 340. In this case, the data also may be sent to the first node. The continuity manager may maintain a record of data sent by other nodes or otherwise transferred among nodes during the session, recorded data sent by the continuity manager, or both to reduce or prevent duplicate data from being sent to the new node. In an embodiment, the recorded data may facilitate recording, interception, or monitoring of a session.

Alternatively, several nodes A, A′, B, and/or C may be connected to a mixed session (such as a multimedia conference), and a session device disconnected. In such a configuration the session may be shared among the connected nodes, and step 350 may be performed prior to step 340.

Since both the first node and the new node may be connected to the continuity manager and the session for overlapping periods of time, there may be some overlap in data sent from the first node, the new node, or both. The overlap may be, for example, a mixing of streams or conferencing across the different streams in a mixed session. At 360, the system may examine data previously sent and currently being transferred from the first node and the new node to determine whether overlap may have resulted in duplicate data transfers. As a specific example, a second node may send data to the first node before the new node is connected to the session, and the continuity manager may store the sent data. When the new node is connected, the continuity manager may send the stored data to the new node as if it was sent to the new node by the second node. The first node may remain connected to the session long enough to send a reply to the second node's data. Since the new node received the data from the second node, it may also send a reply which may be the same as the reply sent by the first node, or may be different.

In another embodiment, data transferred between nodes may not be mixed, a mixed conference may not connect properly, or other situations may occur where the first node should disconnect before the new node is connected. In such cases, the first node may disconnect before the new node is connected. Thus, data may be stored by the continuity manager and forwarded to the new node instead of managing overlap of data caused when both nodes are connected to the session. In an embodiment, it may be preferred to have overlap so as to avoid loss of data.

In an embodiment, the system may reconcile any duplicate or conflicting data transferred in the session at 370. For example, the continuity manager may implement rules specifying which data should be given priority. As a specific example, in the overlap scenario previously described the continuity manager may select the most recently-sent reply, and only transfer that reply to the second node. As another example, the continuity manager may select data transfers identified as being a higher priority or urgency, and discard conflicting or duplicate data transfers. The continuity manager also may identify portions of shared or mixed data that may have been missed by the new node but which other nodes in the session believe was properly received by the first node. Other rules and methods may be used to resolve conflicting or duplicate data. Duplicate data may occur, for example, where data cannot be mixed or a conference cannot be properly connected, or where there is overlap between nodes that is not properly accounted for when data transferred between nodes is mixed.

At 380, the continuity manager may transfer or allow transfer of data from the new node to the second node, or otherwise allow or manage mixing and sharing of data between the new node and the second node. In an embodiment, the continuity manager may not indicate to other nodes in the session that the session has been forwarded from the first node to the new node. That is, from the perspective of other nodes in the session it may appear that they have been in communication with a single node during and after the transfer from the first node to the new node.

The continuity manager may continue to store streaming media data transferred during the session after the session is forwarded to the new node. Additional forwarding may occur, such as where the new node, second node or another node in the session requests that the session for that node be forwarded to yet another node. As a specific, non-limiting example, a user may be connected to a streaming media session via a cellular phone (first node), and request the session be transferred to a computer, PSTN telephone, VoIP client on the same or a different device, or other node (the new node), for example if the user enters an area without cellular service. Later, the user may request a second session transfer, for example back to the cellular phone if he regains cellular service, or to a portable computer that has wireless network access. Other physical node types and transfer scenarios may be implemented without departing from the invention.

The session forwarding methods and systems described herein may be implemented regardless of the specific network, the physical implementation of each node, and the media sent during the session. For example, a session may be forwarded from a telephone to a personal computer regardless of the specific physical and communication protocols implemented by each device.

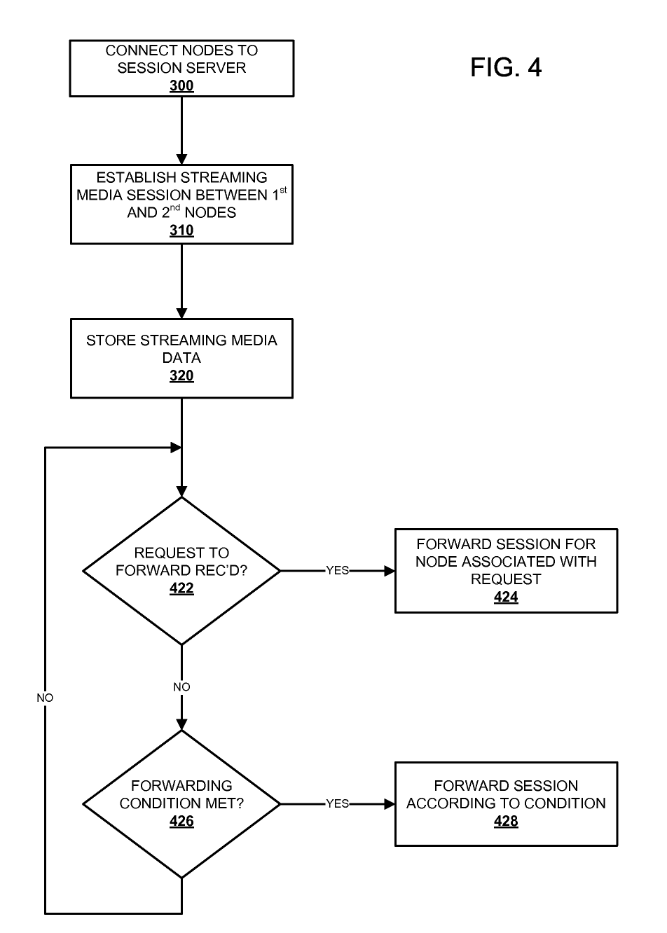

A session may be forwarded automatically, in response to a request to forward the session, or based on other rules, events, or circumstances. FIG. 4 shows a process for forwarding a session according to an embodiment of the invention. As previously described, nodes may connect to a continuity manager (300), a streaming media session may be established between two or more nodes (310), and the continuity manager may store data transferred during the session (320).

At a point during the session, the continuity manager may receive a request to forward the session for one of the nodes in the session at 422. The request may be received, for example, by an application that is part of a media server and/or call control service. The request may be generated by the node for which the session is to be transferred, by another node in the session, or by a third party. It may be sent to the continuity manager as part of the session communications, or via an outside channel such as a separate network connection. The request may be initiated by a user of one of the nodes in the session or another user, or it may be generated automatically by one of the nodes or a third party. In some cases, a request may be sent due to a condition being met as described below. When the request is received, the system may forward the session for the appropriate node at 424 as previously described with respect to FIG. 3.

At 426, a forwarding condition may be fulfilled. A forwarding condition may relate to a user, a node in the session, the network over which the session takes place, the continuity manager, or any other environmental or system-related item. A forwarding condition may be specified by a user, a node, the continuity manager, a third party, or another entity. A forwarding condition also may be defined by a combination of user action and a preset condition, or defined in a policy or other machine-readable set of requirements or conditions. It may be set prior to the session being connected or at some time during the session. A node may have a preset or otherwise built-in forwarding condition, such as where a user agent includes a programmed forwarding condition stored in memory. A forwarding condition may be identified by the continuity manager, or it may be identified by a node or other party. If identified by the continuity manager, the continuity manager may forward the session for a node related to the forwarding condition. If identified by a node or other entity, the node may send a forwarding request to the continuity manager.

Specific, non-limiting examples of forwarding conditions include connection cost, connection quality, network latency, user preferences, presence information for a node or a user, one or more nodes entering a specified state, or any combination thereof. Other conditions may be used as forwarding conditions. As a specific example, a node may be configured to measure or monitor aspects of the node's connection to the session, such as cost, quality, duration, or other aspects. In such a configuration, the forwarding condition may be a specified value or range for the monitored aspect, such that when the monitored aspect lies outside the value or range the node sends a forwarding request to the continuity manager. Thus, for example, a node may be configured to be cost efficient by causing the session to be forwarded if the cost of the session is too high, and/or if a less costly connection is available. Similarly, a node may be configured to send a forwarding request or otherwise cause a session to be forwarded so as to maintain the node's connection to the session at a certain quality.

As another specific example, a session continuity manager may monitor presence information for one or more nodes and, based on the presence information, forward the session for each node appropriately. In general, “presence” refers to a way to detect whether a node is available. For example, when a device becomes available on a network it may appear as a “network presence” when it registers with the network. As another example, a device may register itself via a user agent to a presence server on the network. A presence network agent also may capture a network registration and register it with the presence agent. Presence information and its use in a streaming media session is further described in U.S. application Ser. No. 12/045,220 entitled “Presence-Based Event-Driven Architecture,” filed Mar. 10, 2008, the disclosure of which is incorporated by reference in its entirety for all purposes. This application describes, in part, ways to use presence to capture events and conditions on a network. This information may be used to determine when and/or how to forward a session. Other forwarding conditions may similarly be used.

During a session, the system may enter a wait state in which it awaits a forwarding condition or the occurrence of a forwarding condition, as shown by the loop through steps 422-428. That is, the session may progress normally until a request or forwarding condition causes the session for a node to be forwarded.

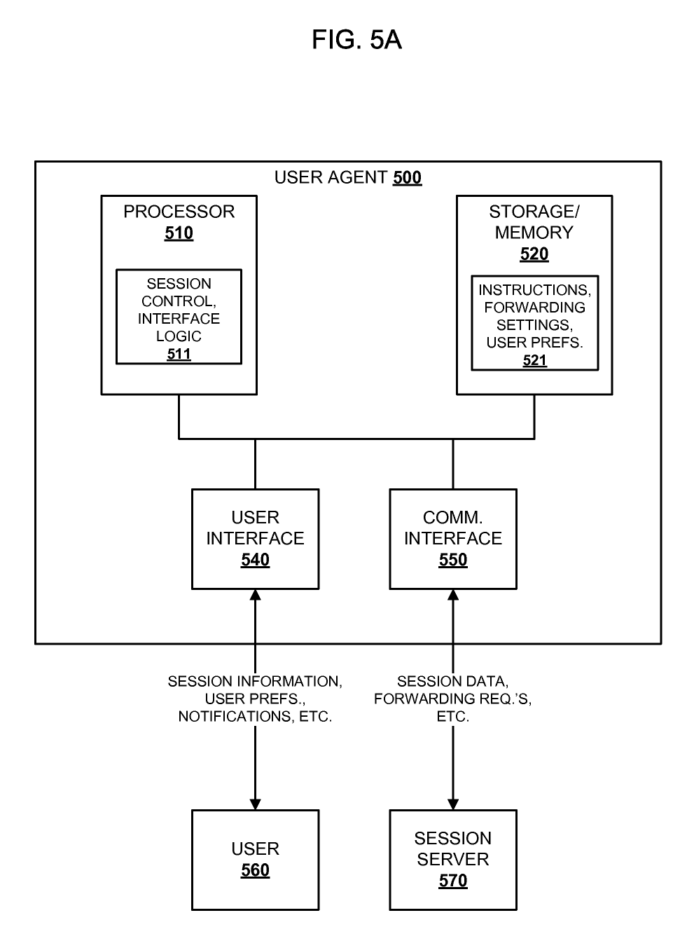

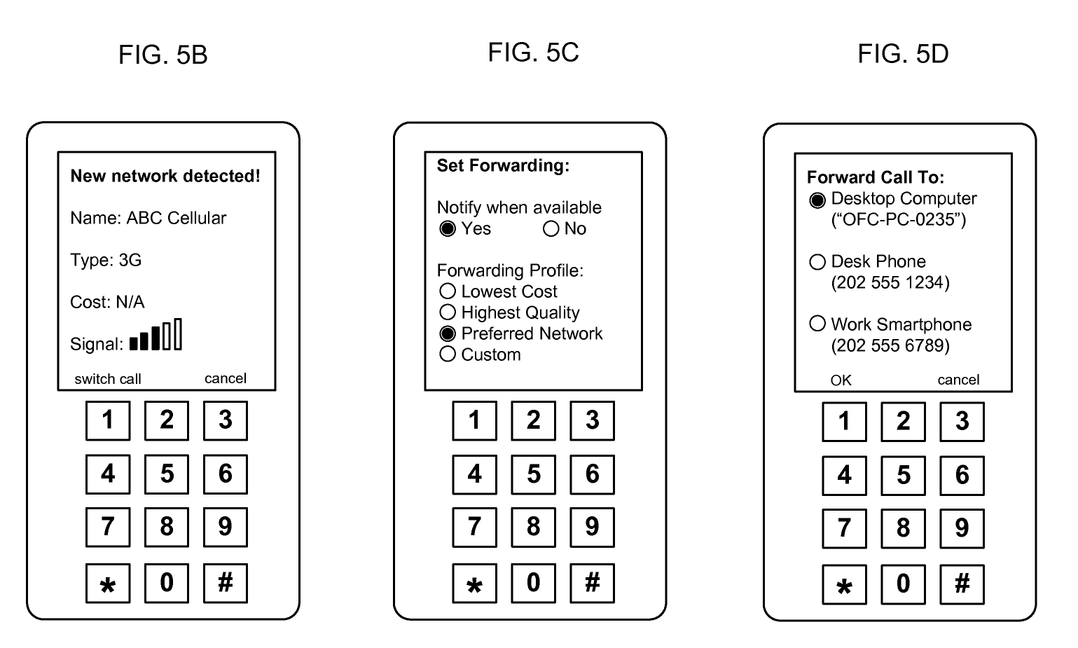

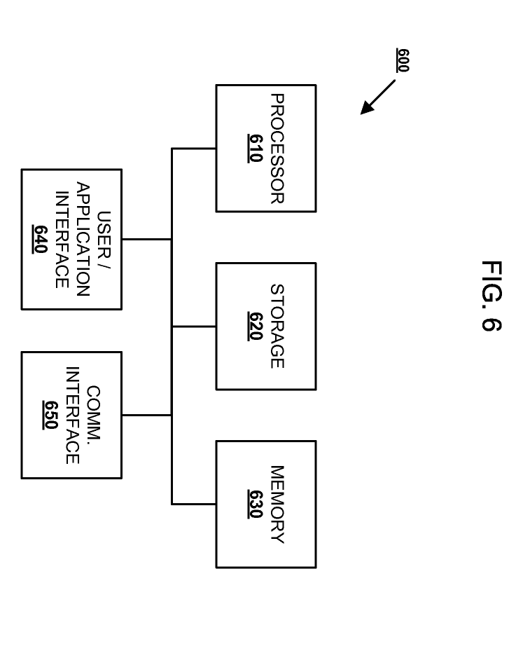

FIG. 5A shows a schematic illustration of a user agent 500 according to an embodiment of the invention. The user agent 500 may be implemented on or integrated with a personal data assistant (PDA), cellular phone, smart phone, general purpose computer, or any other suitable device. The user agent may include a processor 510 to execute instructions stored on a computer-readable storage medium or other memory 520. The processor may, for example, implement session control, interface logic, and other functions 511 of the user agent as described herein. The storage 520 also may store forwarding settings, user preferences, and other configuration options 521 as described herein. A user interface 540 in communication with the processor 510 and the memory 520 may present session information and data, user preferences, notifications, and other items to a user 560 as described herein. It also may receive information from the user, such as preference information, session settings, and other data. The user interface 540 may be, for example, a screen with a graphical user interface, one or more physical controls such as a button, dial, etc., a speaker, a microphone, or any combination thereof. A communication interface 550 in communication with the processor 510, storage 520, and interface 540 may communicate with a remote device such as a session continuity manager 570. The communication interface may send session data constructed by the user agent and receive session data from other members of the session. The communication interface also may send forwarding requests or other items relating to the session that are not part of the session data sent between endpoints in the session.

Similarly, an computer-executed application configured to operate as a node according to an embodiment of the invention may be structurally similar to the user agent device 500 shown in FIG. 5A. However, such an application may include an application interface instead of the user interface 540, which may provide information to another external application or device.

According to an embodiment of the invention, a user agent may allow a user to perform various functions related to session forwarding as described herein. For example, the user agent may allow a user to set a global preference specifying when any session to which the user agent is connected should be forwarded. Similarly, a user may set a session-specific preference indicating when a specific session should be forwarded. User agent functionality may be provided via any appropriate type of user interface, including a hardware interface, a software interface, or a combination thereof. The interface may be, for example, a menu system displayed on a screen and accessed via a series of buttons on the user agent or similar controls, such as the screen and button system used in cellular phones and other portable electronic devices. Other user interfaces may be used.

FIGS. 5B-5D shows an example of a user interface for forwarding a call according to embodiments of the invention. In FIG. 5B, the user interface presents information indicating that an in-progress session can be forwarded, in this case to a new network. The user may forward the session by selecting “switch call,” or choose to maintain the session on the present network by selecting “cancel.” Other information and options may be presented. FIG. 5C shows a user interface for setting forwarding conditions, such as whether to notify the user when a session can be forwarded. The interface also provides a list of pre-set profiles, each of which may include specific forwarding conditions that can be applied automatically or after user notification and confirmation in the future. For example, the “lowest cost” profile may automatically forward a progress to a new lower-cost network. Other profiles may be used, and profiles may be linked to or incorporate policies or other sets of conditions and rules regarding session forwarding. FIG. 5D shows a user interface according to an embodiment of the present invention in which a user may select between other nodes for forwarding. The interface may be used during an in-progress session, or to set a node to which a session will be forwarded in the future. In the example interface, the user may choose to forward the session on a mobile phone to a desktop computer, a desk phone, or another mobile phone such as a different smart phone. In some embodiments, one or more of the nodes to which the session may be forwarded is on the same physical device as the node from which the session is forwarded. The specific device shown in FIGS. 5B-5D is provided as an illustration only, and it will be understood that other devices and interfaces may be used without departing from the scope of the invention. Similarly, other means of interfacing with a user may be used, such as voice command, SMS messages, a web-based interface, or any other suitable interface.

According to an embodiment of the invention the user may set a forwarding condition as previously described. For example, the user may set a preference indicating that a session should be forwarded if a session connection quality, radio signal, available bandwidth, or other metric falls below a specified threshold. In some embodiments a service provider may use various metrics to determine when sessions should be forwarded or when a user should be able to forward a session. For example, roaming calls may be more expensive to provide, so a service provider may prefer to forward calls to non-roaming networks when possible.

According to embodiments of the invention, the user agent may include functionality to notify the user that a session is being forwarded or has been forwarded, such as playing a sound or announcement, presenting session forwarding information on a display, activating a vibration function in the user agent, or other functionality.

According to an embodiment of the invention, the user agent may include functionality to allow a user to force a session to be forwarded to another node, even if no other forwarding condition or forwarding request exists. For example, the user may initiate a session to another device and thus prompt the session to be forwarded to the other device.

According to an embodiment of the invention, the user agent may include functionality allowing a user to query the user agent or another entity regarding the possibility or availability of a node to which a session may be forwarded. For example, the user agent may provide an interface listing nodes to which a session may be forwarded, available networks that support session forwarding, or other entities that indicate a session may be forwarded.

According to an embodiment of the invention, the user agent may provide the option for a user to “recall” a forwarded session. For example, a user agent may maintain a list of previously-forwarded sessions and allow a user to select a session to be “recalled” to the user agent. When a session is forwarded, the original node may maintain a reference or identifier of the session. An interface may allow a user to see information about a recently-forwaded call, including state information that indicates whether the session is still continuing somewhere else, whether the node can still access the session, or other information. A user may then “recall” the session by selecting an option in a user interface, thus causing the user's node to re-join the conference. In an embodiment, when a user selects a forwarded session to be recalled the user agent may send a forwarding request for the session, indicating that it should be forwarded from another node to the user agent.

According to embodiments of the invention, the user agent may allow the user to set other preferences regarding session forwarding and continuation, such as whether session forwarding requires confirmation from the user, what types of nodes to prefer for session forwarding, what notification, if any, should be used for session forwarding, whether to automatically forward a session, and other preferences.

A user agent according to embodiments of the present invention may include a user interface, such as the user interfaces 115, 116 shown in FIGS. 1 and 2. The user interface may be implemented in hardware, software, or a combination thereof. For example, the user agent functionality described herein may be implemented as a set of buttons, menus, or other user interface elements that allow for control of the session functionality described herein.

The methods described herein may be partly or wholly implemented on or from a handset, computer interface, personal data assistant (PDA), or other item that interfaces with a user. Such a device may be referred to as a user agent. A user agent may be a node as described herein, such as where a user connects to a session via a cellular phone, or it may be a device that connects to a session via another node, such as where a computer connects to a session via an intermediary computer, or a phone connects to a session via a PBX or other device. FIG. 6 shows a simplified schematic of an example device 600 suitable for use in the invention. The device may be part of or used to implement a user agent, session continuity manager, or other computerized device as described herein. The device 600 may be a general purpose computer, cellular or other telephone, web conferencing system, videoconferencing system, or other node as described herein. The device may include a processor 610 capable of executing instructions stored on a computer-readable storage medium 620. Data used and created by the device also may be stored on the storage medium 620. The instructions, data, or combinations thereof also may be stored in other memory 630, such as volatile or other memory. The device may include a user or application interface 640 capable of providing data to, and receiving data from, a user of the computer or an external application, respectively. The device 600 also may include a communication interface 650, such as a network interface, capable of communicating with a storage device, user, or other entity that may be directly connected to or remote from the device. The communication interface 650 may connect to a session continuity manager as described with respect to FIGS. 1-2. Other devices and structures may be included.

In the foregoing description, for the purposes of illustration, methods were described in a particular order. It should be appreciated that the methods may be performed in a different order than that described. Additionally, unless indicated otherwise the methods may contain additional steps or omit steps described herein. The methods may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more computer-readable storage media, such as CD-ROMs or other type of optical disks, floppy diskettes, ROMs, RAMs, EPROMs, EEPROMs, magnetic or optical cards, flash memory, or other types of machine-readable media suitable for storing electronic instructions. The methods also may be performed by a combination of hardware and software.

Unless described otherwise herein, any communication or network connection may be made over any suitable network and using any suitable communication protocol. Suitable network topologies and protocols include, without limitation, TCP/IP, SNA, IPX, AppleTalk, PSTN, wireless networks such as IEEE 802.11-compliant networks, Bluetooth, GSM, GPRS, EDGE, UMTS, 3G, 2.5G, CDMA and variants, EVDO, and combinations thereof.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of forwarding an in-progress media streaming session, comprising:
during a media streaming session between a first node and a second node during which each of the first node and the second node is connected to a session continuity manager, storing data exchanged between the first node and the second node;
initiating a new connection between a new node and the session continuity manager;
disconnecting the first node; and
continuing the session at the new node from the first node.

2. The method of claim 1, wherein, data is mixed among the first node, the second node, and the new node while the nodes are connected to the session.

3. The method of claim 1, wherein duplicate data is sent to at least two of the first node, the second node, and the new node during the session.

4. The method of claim 1, wherein the first node is disconnected from the session after the new connection is established.

5. The method of claim 1, wherein the first node is disconnected from the session before the new connection is established.

6. The method of claim 1, further comprising sending stored data previously sent by the second node to the new node.

7. The method of claim 1, further comprising:
forwarding at least one of data sent by the first node and data sent by the new node to the second node, wherein the forwarded data is identified as originating at the new node.

8. The method of claim 7, wherein the forwarded data is read from the database prior to forwarding to the second node.

9. The method of claim 1, wherein data is sent from the new node to the second node before the first node is disconnected.

10. The method of claim 1, wherein session data is replicated between the first node and the new node.

11. The method of claim 1, wherein the new connection is initiated by the new node.

12. The method of claim 1, wherein the new connection is initiated by the session continuity manager.

13. The method of claim 1, wherein during initiation of the new connection, the session continuity manager identifies itself to the new node as the second node.

14. The method of claim 1, wherein the session continuity manager, the first node, and the new node are connected by a third party call control mechanism.

15. The method of claim 1, wherein the connection between the new node and the session continuity manager is initiated in response to a request to forward the session to the new node.

16. The method of claim 15, wherein the request is made prior to initiation of the media streaming session between the first node and the second node.

17. The method of claim 15, wherein the request is made automatically based on a preference of at least one of the nodes.

18. The method of claim 15, wherein the request is initiated by a user of at least one of the first node and the second node.

19. The method of claim 15, wherein the request is made via a channel separate from the media streaming session.

20. The method of claim 15, wherein the new node is on a separate network from the first node.

21. The method of claim 1, wherein at least one of the first node and the second node is connected to the session continuity manager after initiation of the media streaming session.

22. The method of claim 1, wherein the first node and the new node are on different networks.

23. The method of claim 1, wherein the media streaming session is an audio session.

24. The method of claim 23, wherein the nodes are connected via at least one of a PSTN network, a PBX, an IP network, and a cellular telephone network.

25. The method of claim 1, wherein the media streaming session is a video session.

26. The method of claim 25 wherein the first node is a mobile TV node or an IPTV node, and the new node is a mobile TV node or an IPTV node.

27. The method of claim 1, wherein the media streaming session is a web conference.

28. The method of claim 1, wherein the session continuity manager comprises a media server.

29. The method of claim 28, wherein at least one of the first node, the second node, and the new node is connected to the session by a call controller separate from the media server.

30. The method of claim 28, wherein the media server stores data transferred during the session, monitors data transferred during the session, or both.

31. A session continuity manager comprising:
a database to store session data distributed to a first node and a second node connected to the session continuity manager during a media streaming session; and
a media server in communication with the database, the media server configured to receive a connection from a new node during the session and continue the session at the new node from the first node.

32. A system comprising:
a database configured to store session data for a media streaming session between a first node and a second node; and
a session continuity manager in communication with the database, the session continuity manager configured to communicate with a plurality of nodes including the first node and the second node;
wherein the session continuity manager is configured to forward the media streaming session from the first node to a new node while the media streaming session is in progress.

33. A computer-readable storage medium storing a plurality of instructions which, when executed by a processor, cause the processor to perform method of forwarding an in-progress media streaming session, the method comprising:
during a media streaming session between a first node and a second node during which each of the first node and the second node is connected to a session continuity manager, storing data exchanged between the first node and the second node;
initiating a new connection between a new node and the session continuity manager;
disconnecting the first node; and
continuing the session at the new node from the first node.

34. A network system comprising a database and a central server in communication with a plurality of remote user nodes, the system configured to:
establish a first connection between a first remote user node and the central server;
establish a second connection between a second remote user node and the central server;
establish a media streaming session between the first remote user node and the second remote user node through the first and second connections;
store information regarding the media streaming session in the database; and
while the media streaming session is in progress, and without interrupting the media streaming session, forward the media streaming session from the first node to a third node distinct from the second node.
